(19) United States
(12) Patent Application Publication
(10) Pub. No.: US 2012/0222886 A1
(43) Pub. Date: Sep. 6, 2012

(54) ELECTRONIC DEVICE WITH WIRE FIXING STRUCTURE

(75) Inventors: JI-FENG QIU, Shenzhen City (CN); KE-HUI PENG, Shenzhen City (CN); LI-NI LIANG, Shenzhen City (CN); REN-WEN WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/100,973

(22) Filed: May 4, 2011

(30) Foreign Application Priority Data
Mar. 3, 2011 (CN) 201110051060.2

(51) Int. Cl. H01B 7/00

(52) U.S. Cl. 174/135

(57) ABSTRACT

An electronic device includes at least an electric wire, a first cover, and a second cover. The electric wire is mounted between the first cover and the second cover. The first cover includes a wire retainer integrally forming a restraining portion to fix the electric wire on the first cover. The second cover includes a hook securely engaged with the wire retainer of the first cover to fix the second cover on the first cover.

### BACKGROUND

1. Technical Field

The disclosure relates to electronic devices and more particularly to an electronic device with a wire fixing structure.

2. Description of Related Art

In an electronic device such as a disc player or a notebook, wires are held by wire mounts. The wire mounts are fixed to the electronic device by insertion or adhesion. The wire mounts may occupy space required for other components in the electronic device, necessitating rearrangement of the components, thereby complicating design.

What is needed, therefore, is an electronic device which can overcome the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric, partial view of an electronic device in accordance with an embodiment of the disclosure.

FIG. 2 is an assembled, partial view of the electronic device of FIG. 1.

### DETAILED DESCRIPTION

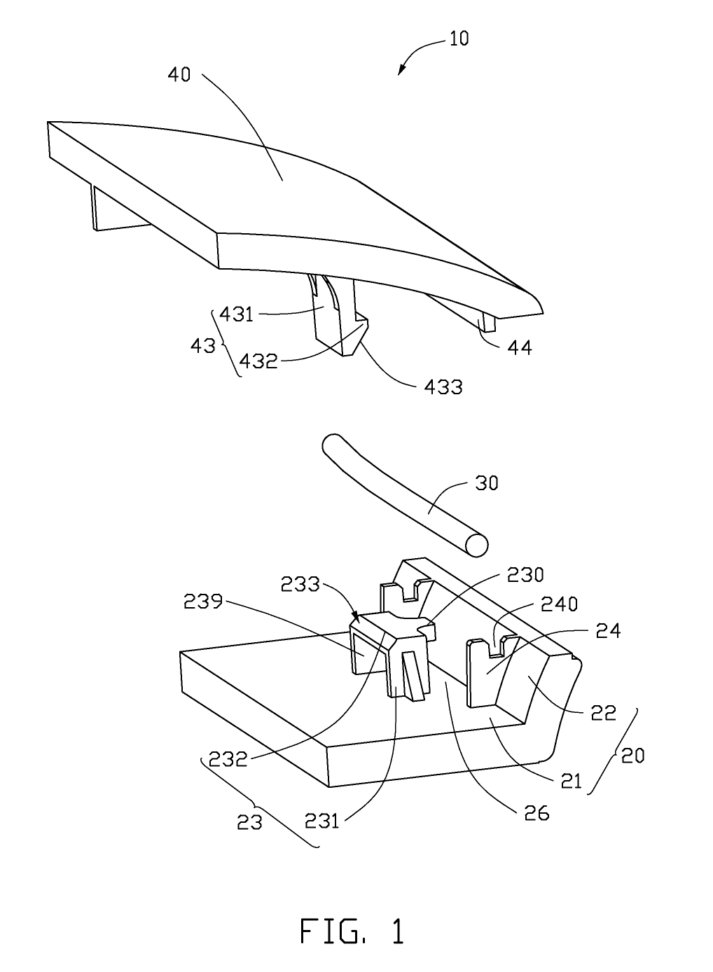

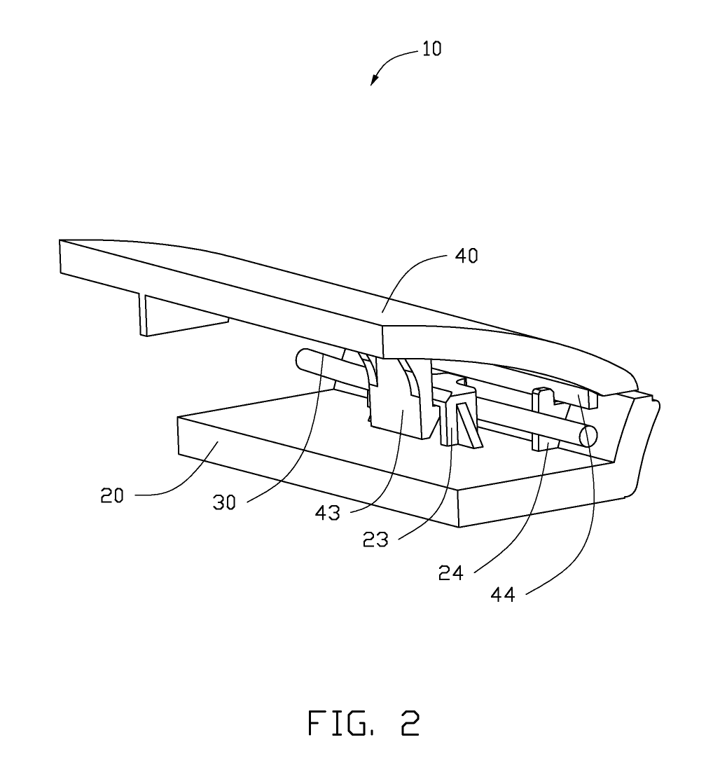

Referring to FIGS. 1-2, an electronic device 10 in accordance with an embodiment of the disclosure is shown. The electronic device 10 includes a first cover 20 and a second cover 40. The first cover 20 includes a wire retainer 23. The second cover 40 includes a hook 43 clasping the wire retainer 23.

The first cover 20 is a base of the electronic device 10, and comprises a bottom plate 21 and a lateral plate 22 extending from an edge of the bottom plate 21. The second cover 40 is mounted on the first cover 20 and abuts against a top of the lateral plate 22.

The wire retainer 23 is mounted on a top surface of the bottom plate 21 and positioned near the lateral plate 22. The wire retainer 23 includes two supporting portions 231, a connecting portion 232 connected with tops of the supporting portions 231. A restraining portion 230 is fixed on the central portion of the connecting portion 232 and toward the lateral plate 22. The supporting portions 231 and the connecting portion 232 together define a fixing hole 239 in the wire retainer 23. The connecting portion 232 has an inclined contact surface 233 at a side thereof opposite to the restraining portion 230. Two walls 24 extend from the lateral plate 22 and are fixed on the lateral plate 22 and bottom plate 21. The wire retainer 23 is positioned near ends of the lateral plate 22 and the restraining portion 230 extends toward the middle of the walls 24. A space 26 is defined between the supporting portions 231 and the walls 24 to receive the electric wire 30. The restraining portion 230 is disposed above the space 26 for limiting vertical movement of the electric wire 30 in the space 26. Alternatively, the restraining portion 230 can be hook or L-shaped. Each of the walls 24 defines a notch 240 in a top thereof.

The hook 43 of the second cover 40 extends down from an inner surface of the second cover 40. The hook 43 includes an elastic portion 431 and a buckling portion 432 extending from a free end of the elastic portion 431 toward the wire retainer 23. The buckling portion 432 has an inclined engaging surface 433 corresponding to the contact surface 233 of the wire retainer 23. An inserting plate 44 extends down from the second cover 40 toward the walls 24. The inserting plate 44 is spaced from the hook 43 and received in the notches 240 of the walls 24.

In assembly, the electric wire 30 is received in the space 26 and between the wire retainer 23 and ends of the walls 24, and blocked by the restraining portion 230. The second cover 40 is mounted on the first cover 20 with the inserting plate 44 engaged in the notches 240 of the walls 24. When the hook 43 moves to the wire retainer 23, the inclined engaging surface 433 of the hook 43 contacts the inclined contact surface 233 of the wire retainer 23 to drive the buckling portion 432 sliding into the fixing hole 239. Thus, the hook 43 securely clasps the wire retainer 23 to fix the second cover 40 on the first cover 20.

It is to be understood, however, that even though numerous characteristics and advantages of certain embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An electronic device comprising:
a first cover comprising a wire retainer integrally forming a restraining portion for fixing an electric wire on the first cover; and
a second cover comprising a hook securely engaged with the wire retainer of the first cover to fix the second cover on the first cover.

2. The electronic device of claim 1, wherein the first cover comprises two walls extending therefrom, the restraining portion of the wire retainer extending toward a midway point between the walls, the electric wire being disposed between the wire retainer and the walls and blocked by the restraining portion.

3. The electronic device of claim 2, wherein each of the walls defines a notch in a top thereof, an inserting plate extending from the second cover to engage in the notches of the walls.

4. The electronic device of claim 2, wherein the wire retainer comprises two supporting portions and a connecting portion connected with tops of the supporting portions, the restraining portion is fixed on central portion of the connecting portion.

5. The electronic device of claim 4, wherein the hook comprises an elastic portion and a buckling portion extending from a free end of the elastic portion, the buckling portion securely engaging with the wire retainer.

6. The electronic device of claim 5, wherein the connecting portion has an inclined contact surface at a side thereof opposite to the restraining portion, the buckling portion having an inclined engaging surface corresponding to the contact surface of the wire retainer.

7. An electronic device comprising:
an electric wire;
a first cover, the first cover comprising a wire retainer and two walls, the wire retainer forming a restraining portion extending toward a midway point between of walls, the wire retainer and walls surrounding the electric wire; and
a second cover, the second cover comprising a hook securely engaged with the wire retainer of the first cover to fix the second cover on the first cover.

8. The electronic device of claim 7, wherein the restraining portion blocks a top of the electric wire.

9. The electronic device of claim 7, wherein each of the walls defines a notch in a top thereof, an inserting plate extending from the second cover to engage in the notches of the walls.

10. The electronic device of claim 7, wherein the wire retainer comprises two supporting portions and a connecting portion connected with tops of the supporting portions, the restraining portion is fixed on a central portion of the connecting portion.

11. The electronic device of claim 10, wherein the hook comprises an elastic portion and a buckling portion extending from a free end of the elastic portion, the buckling portion securely engaging with the wire retainer.

12. The electronic device of claim 11, wherein the connecting portion has an inclined contact surface at a side thereof opposite to the restraining portion, the buckling portion having an inclined engaging surface corresponding to the contact surface of the wire retainer.
